(19) United States
(12) Patent Application Publication
(10) Pub. No.: US 2017/0237851 A1
(43) Pub. Date: Aug. 17, 2017

(54) CALL LEG QUALITY DIFFERENTIATION IN NETWORK TELEPHONY SYSTEMS

(71) Applicant: Microsoft Technology Licensing, LLC, Redmond, WA (US)

(72) Inventors: Amer Hassan, Kirkland, WA (US); Gunter Leeb, Redmond, WA (US); Mitchelle Fernandes Gonsalves, Redmond, WA (US); Pascal Menezes, Bellevue, WA (US)

(21) Appl. No.: 15/045,532

(22) Filed: Feb. 17, 2016

(51) Int. Cl. H04M 3/22; H04M 7/00; H04L 12/26

(52) U.S. Cl. CPC H04M 3/2227; H04L 43/08; H04M 7/006

(57) ABSTRACT

Network telephony monitoring systems are provided herein. In one example, a monitoring service is configured to present an interface for a network telephony monitoring system to receive link metrics for media legs of a packet voice call that extends from an originating network over a plurality of transport networks, with each of the media legs spanning between border control nodes of the plurality of transport networks. A leg quality processor is configured to process the link metrics to differentiate quality degradation of the packet voice call among one or more of the media legs.

### BACKGROUND

Network telephony systems and applications, such as Voice over Internet Protocol (VoIP) systems and Skype® systems, have become popular platforms for not only providing voice calls between users, but also for video calls, live meeting hosting, interactive white boarding, and other point-to-point or multi-user network-based communications. These network telephony systems typically rely upon packet communications and packet routing, such as the Internet, instead of traditional circuit-switched communications, such as the Public Switched Telephone Network (PSTN) or circuit-switched cellular networks.

In many examples, communication links can be established among user devices to provide voice and video calls or interactive conferencing within specialized software applications on computers, laptops, tablet devices, smartphones, gaming systems, and the like. As these network telephony systems have grown in popularity, users have found that call interruptions, jitter, lag, and other problems have emerged which differ from circuit-switched communications. These issues can be especially pronounced when the communications extend over more than one network or over portions of the Internet, which comprise a vast diversity of routing components and systems.

### OVERVIEW

Systems, apparatuses, platforms, and methods that employ network telephony and conferencing monitoring systems are provided herein, such as Internet telephony systems, Voice over Internet Protocol (VoIP) systems (e.g. Skype®, Skype® for Business, Microsoft Lync®), group conferencing, or other network communication systems. In one example, a monitoring service is configured to present an interface for a network telephony monitoring system to receive link metrics for media legs of a packet voice call that extends from an originating network over a plurality of transport networks, with each of the media legs spanning between border control nodes of the plurality of transport networks. A leg quality processor is configured to process the link metrics to differentiate quality degradation of the packet voice call among one or more of the media legs.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 is a system diagram of a network telephony environment in an implementation.

FIG. 2 illustrates a method of operating a network telephony monitoring system in an implementation.

FIG. 3 is a system diagram of a network telephony system in an implementation.

FIG. 4 illustrates a table indicating example link/quality metrics, parameters, alerts, and remediation in an implementation.

FIG. 5 illustrates an example computing platform for implementing any of the architectures, processes, methods, and operational scenarios disclosed herein.

### TECHNICAL DISCLOSURE

Network communication systems and applications, such as Voice over Internet Protocol (VoIP) systems, Skype® systems, Skype® for Business systems, Microsoft Lync® systems, and online group conferencing, can provide voice calls, video calls, live information sharing, and other interactive network-based communications. Communications of these network telephony and conferencing systems can be routed over one or more packet networks, such as the Internet, to connect any number of endpoints. More than one distinct network can route communications of individual voice calls or communication sessions, such as when a first endpoint is associated with a different network than a second endpoint. Border control elements can communicatively couple these different networks and can establish communication links for routing of network telephony traffic between the networks. These border control elements can include session border controllers (SBCs) in VoIP examples, and can also include nodes to egress communications over different types of networks, such as voice gateways when communications are directed to an endpoint on a PSTN network or packet gateways when communications are directed to an endpoint on a wireless or cellular network.

End-to-end voice connections often involve many networks to transport network telephony communication links, which can be referred to as media streams or media paths. Network conferencing systems can involve many different networks to transport group communications among members, which can connect through individual endpoint networks. In addition, several different communication technologies may be employed and bridged among these different networks. It can be difficult to collect information about communication session quality of the media streams through every section of the media path. Special protocols, such as Real-time Transport Protocol (RTP) Control Protocol (RTCP), can be used to exchange measurements on the quality of the media stream over an RTCP loop between two routing points of individual media legs of the media stream. Usually, when a media stream leaves a network operated by a particular network operator, such as through an SBC of that particular network, no visibility into the quality of the media leg outside of that network is provided.

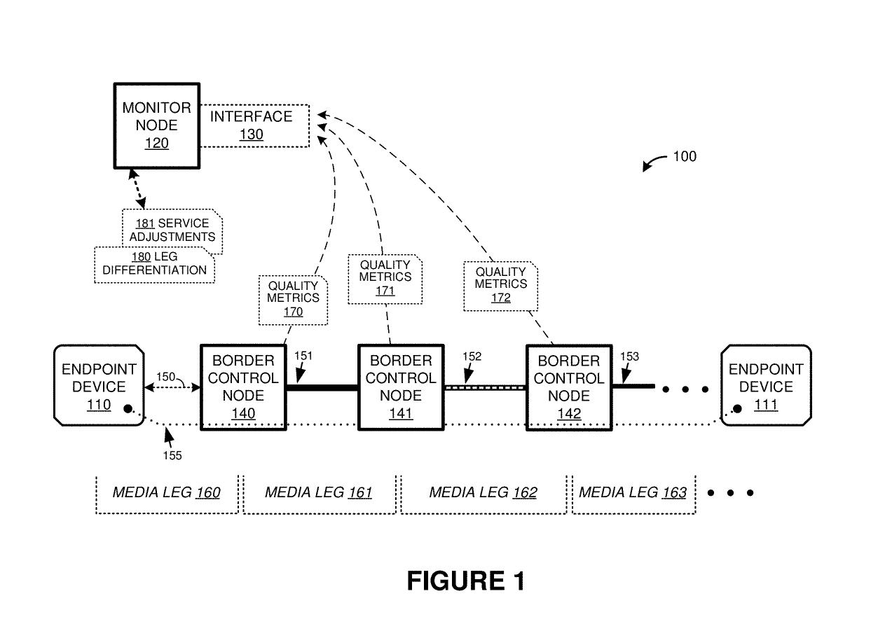

To provide enhanced operation of network telephony monitoring systems, various examples are provided below. In a first implementation, FIG. 1 is a system diagram of network telephony environment 100. Environment 100 includes endpoint devices 110-111, monitor node 120, interface 130, and a plurality of border control elements 140-142. Endpoint device 110 and border control node 140 communicate over link 150. Packet links 151-153 interconnect various networks and network control elements of FIG. 1. In operation, packet voice call 155 is extended between endpoint device 110 and endpoint device 111 over link 150 and links 151-153. Packet voice call 155 comprises a plurality of media legs, namely media legs 160-163 which together can comprise a media stream or media path. In some examples, these media legs each comprise a SIP trunk.

Although FIG. 1 shows two endpoint devices communicating over packet voice call 155, it should be understood that other examples can include more than two endpoint devices. In network conferencing examples, more than two endpoints can be coupled into a single communication session, such as in a conference call or shared video environment. Similar monitoring and interfacing techniques can be applied, with possibly more diverse networks and border control elements provided for links associated with the multiple endpoints.

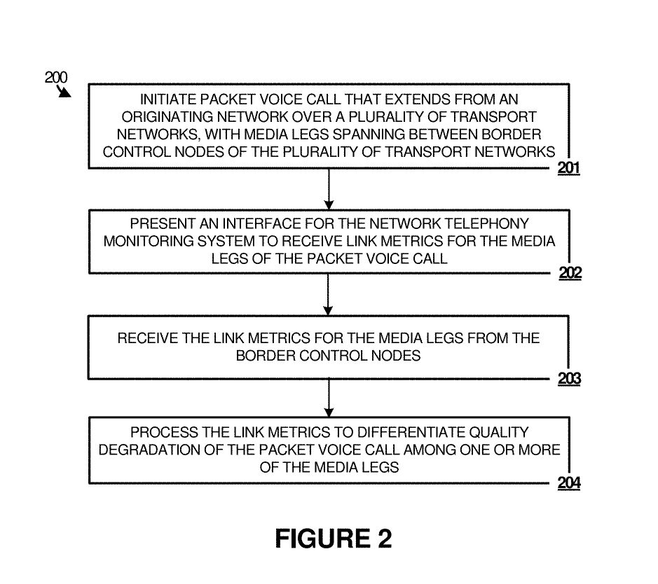

To further illustrate the operation of the elements of FIG. 1, FIG. 2 is provided. FIG. 2 is a flow diagram illustrating method 200 of operating the elements of FIG. 1 in an implementation. The operations of FIG. 2 are indicated below parenthetically.

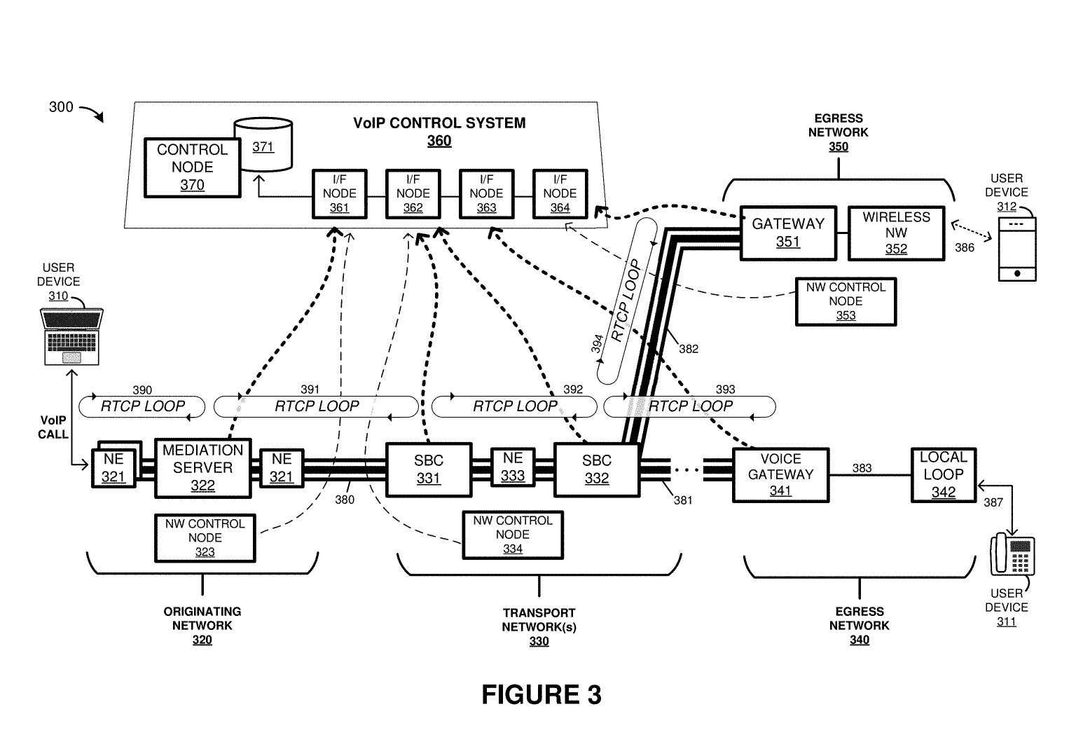

In FIG. 2, endpoint device 110 initiates (201) packet voice call 155 that extends from an originating network over a plurality of transport networks, with media legs spanning between border control nodes 140-142 of the plurality of transport networks. In FIG. 1, voice call 155 is established over networks associated with border control nodes 140-142, and media legs 160-163 extended between border control nodes 140-142, as well as between the associated endpoints. Link 150 can comprise an end-user link in some examples, or can be handled by one or more ingress nodes, such as mediation servers or VoIP servers. In multi-user communication examples, the packet voice call might instead be a conference-style call and hosted by one or more host systems, such as discussed for mediation server 322 in FIG. 3 below. The multi-user communication examples can include many media paths with many media legs for each individual user to interconnect.

A network telephony monitoring system can be included in a network telephony system and can comprise monitor node 120. Monitor node 120 presents (202) an interface 130 for the network telephony monitoring system to receive link quality metrics 170-172 for the media legs 160-163 of the packet voice call 155. The link quality metrics can comprise network condition metrics, bandwidth limitation metrics, congestion metrics, jitter metrics, packet loss metrics, Mean Opinion Score (MOS) metrics for call quality (CQ) and listening quality (LQ), call admission control (CAC) metrics, transmitted octet counts, packet counts, packet delay variation metrics, and round-trip delay times, among other metrics. The link quality metrics can be determined by at least the border control nodes using Real-time Transport Protocol (RTP) Control Protocol (RTCP) loops established for associated ones of the media legs.

Interface 130 receives (203) the quality metrics for the media legs from the border control nodes, such as over associated communication links (not shown for clarity in FIG. 1) comprising one or more packet links between the border control node and interface 130. In some examples, interface 130 comprises one or more application programming interfaces (APIs) through which border control nodes can push quality metrics. In other examples, interface 130 comprises software defined network (SDN) interface elements, such as interface managers or interface hubs, assigned to border control nodes that can receive quality metrics from the border control nodes.

Monitor node 120 processes (204) the quality metrics to differentiate quality degradation of the packet voice call among one or more of the media legs. For example, monitor node 120 might process quality metrics 170-172 to establish ones of the media legs which are experiencing service degradation below a desired threshold. In FIG. 1, link 152 might be experiencing congestion and has resultant quality degradation for voice call 155. However, in some examples, border control node 141 and border control node 142 are associated with transport networks having different network operators than an originating network associated with endpoint device 110. Thus, the originating network might not have visibility to the current quality state or quality metrics of media leg 162, among other media legs. In this example, border control node 141 and border control node 142 transfer quality metrics for delivery to interface 130 and monitor node 120, and monitor node 120 can advantageously determine individual leg quality. Moreover, monitor node 120 can identify leg differentiation statistics 180 which can indicate which media legs are experiencing degradation or other issues. Service adjustments 181 can also be issued which can alter properties of voice call 155 or subsequent voice calls, such as altering a route, pathway, or selecting different border control nodes to handle the voice calls. In further examples, media properties of the voice call can be altered using service adjustments 181, such as adjustments to a codec, compression scheme, protocol, or other media properties.

Referring back to the elements of FIG. 1, endpoint devices 110-111 each comprise transceiver circuitry, processing circuitry, and user interface elements. The transceiver circuitry typically includes amplifiers, filters, modulators, and signal processing circuitry. Endpoint devices 110-111 can also each include user interface systems, network interface card equipment, memory devices, non-transitory computer-readable storage mediums, software, processing circuitry, or some other communication components. Endpoint devices 110-111 can each be a wireless communication device, subscriber equipment, customer equipment, access terminal, smartphone, telephone, mobile wireless telephone, personal digital assistant (PDA), computer, e-book, mobile Internet appliance, wireless network interface card, media player, game console, or some other wireless communication apparatus, including combinations thereof.

Monitor node 120 comprises computer processing systems and equipment which can include communication or network interfaces, as well as computer systems, microprocessors, circuitry, cloud-based systems, or some other processing devices or software systems, and can be distributed among multiple processing devices. Examples of monitor node 120 can also include software such as an operating system, logs, databases, utilities, drivers, networking software, and other software stored on a computer-readable medium. Monitor node 120 can provide one or more interface elements 130 which can receive link/quality metrics from border control nodes 140-142. These interface elements 130 can be customized and instantiated specifically to interface with different types of border control nodes. In this manner, monitor node 120 and interface 130 can receive link/quality metrics from a plurality of border control nodes which might each communicate over a different protocol, link type, network type, and might each be operated by a different network operator or third-party network entity separate from that of monitor node 120.

Border control nodes 140-142 each include network telephony routing and control elements, and can perform network telephony routing and termination for endpoint devices. Border control nodes 140-142 can comprise session border controllers (SBCs) in some examples which can handle one or more session initiation protocol (SIP) trunks between associated networks. Border control nodes 140-142 each can include computer processing systems and equipment which can include communication or network interfaces, as well as computer systems, microprocessors, circuitry, cloud-based systems, or some other processing devices or software systems, and can be distributed among multiple processing devices. Examples of border control nodes 140-142 can include software such as an operating system, routing software, logs, databases, utilities, drivers, networking software, and other software stored on a computer-readable medium.

Communication links 150-153 each use metal, glass, optical, air, space, or some other material as the transport media. Communication links 150-153 each can use various communication protocols, such as Time Division Multiplex (TDM), Internet Protocol (IP), Ethernet, synchronous optical networking (SONET), asynchronous transfer mode (ATM), hybrid fiber-coax (HFC), circuit-switched, communication signaling, wireless communications, or some other communication format, including combinations, improvements, or variations thereof. Communication links 150-153 each can be a direct link or may include intermediate networks, systems, or devices, and can include a logical network link transported over multiple physical links. In some examples, link 150-153 each comprises wireless links that use the air or space as the transport media.

FIG. 3 illustrates a further example of a communication system in an implementation. Specifically, FIG. 3 illustrates network telephony system 300. System 300 includes user devices 310-312, originating network 320, transport network 330, egress network 340, egress network 350, and VoIP control system 360. Originating network 320 includes network elements (NE) 321, mediation server 322, and network (NW) control node 323. Transport network 330 include session border controller (SBC) 331-332, NE 333, and NW control node 334. More than one transport network can be included, and network telephony calls or media streams can be transported over more than one transport network. Only one transport network 330 is shown in FIG. 3 for clarity. Egress network 340 comprises a public-switched telephone network (PSTN) and includes voice gateway 341 and PSTN local loop circuits 342. Egress network 350 comprises a cellular communication network and includes gateway 351, wireless network 352, and NW control node 353.

Control system 360 includes one or more interface (I/F) nodes 361-364. These nodes can comprise interface elements, such as software defined network (SDN) interface nodes, API interface nodes, interface hubs, or SDN managers. I/F nodes 361-364 comprise Application Programming Interfaces (APIs) for network nodes in FIG. 3 to provide quality metrics. These network nodes are associated with more than one network provider, and each network provider can independently provide these quality metrics over an associated API presented by an associated interface node. The network nodes include SBCs, network control nodes, network elements, and other elements which carry the network traffic associated with VoIP calls. Some nodes, such as SBCs can establish SIP trunks with other SBCs and gateways to carry the VoIP traffic of one or more VoIP calls which can include two-user or multi-user calls. These SIP trunks can be monitored by associated SBCs and associated quality metric data can be provided to an associated interface node in VoIP control system 360.

In VoIP call operations, user device 310 initiates a Voice over Internet Protocol (VoIP) call to an endpoint, such as user device 311 or user device 312. In specific examples, the VoIP call is a Skype-based call, and initiated by a user of user device 310 within an application executed on user device 310. Responsive to the initiation of the VoIP call, user device 310 can communicate with mediation server 322, which establishes the call to a desired endpoint. In a first example, the desired endpoint is user device 311, which is on a PSTN network. In this first example, the call is established over originating network 320, transport network 330, and egress network 340. The originating network can offload transport of traffic associated with the VoIP call to transport network 330 through a border control element or other network element. The transport network 330 can offload the VoIP traffic to a local loop connection to reach an endpoint using egress network 340 and an associated border control element. In a second example, the desired endpoint is user device 312, which is on a cellular or wireless network. In this second example, the call is established over originating network 320, transport network 330, and egress network 350.

In multi-user VoIP call or group conferencing VoIP operations, user device 310 can initiate a Voice over Internet Protocol (VoIP) conference, which might include other endpoints such as user device 311 or user device 312. A user of user device 310 can establish the conference within an application executed on user device 310. Responsive to the initiation of the multi-user VoIP call, user device 310 can communicate with mediation server 322, which hosts the call for all invitees. Similar communication links and media legs can be established as discussed above for two-party VoIP call scenarios, except that media legs to communicatively couple a plurality of endpoints can be employed.

Control node 370 can receive quality metrics from associated I/F nodes 361-364 in control system 360 which receive quality metrics from associated network elements that handle transport of the VoIP call. The quality metrics can be stored in Quality of Experience (QoE) database 371. The quality metrics can correspond to network condition metrics, bandwidth limitation metrics, congestion metrics, jitter metrics, packet loss metrics, Mean Opinion Score (MOS) metrics, transmitted octet counts, packet counts, packet delay variation metrics, and round-trip delay times. Control node 370 can then differentiate the quality degradation of the packet voice call among one or more of the media legs. As mentioned herein, each of the media legs can extend over a SIP trunk between SBCs or other network elements. One or more of the media legs can be identified as having quality degradation. Responsive to differentiating the quality degradation of the packet voice call among one or more of the media legs, control node 370 can transfer one or more alerts indicating at least one of the media legs associated with the quality degradation. These alerts can be transferred to mediation server 322, user device 310, or to other control elements associated with the VoIP call handling. Responsive to differentiating the quality degradation of the packet voice call between one or more of the media legs, control node 370 can alter service parameters employed for the packet voice call, where the service parameters include at least one of a codec, modality, or a route.

In FIG. 3, media legs of the call extend between SBCs as well as ingress/egress nodes (i.e. mediation server 322, voice gateway 341, and gateway 351). During the voice call, one or more RTCP loops are established over corresponding media legs, which monitor quality of each associated media leg of the voice call, and these RTCP loops, are indicated in FIG. 3 as elements 390-394. A media leg is associated with each RTCP loop in FIG. 3, and these media legs might cross more than one network element and network link. These RTCP loops are used to exchange measurements on the quality of the media stream between two end-points of a call leg. An end-to-end voice connection often involves many networks to transport the media path. Similarly, several communication technologies may be used and bridged.

Usually, when a media path leaves an originating network, such as through a Session Border Controller (SBC), no visibility into the quality of the media legs are available to the originating network or to mediation server 322. The examples herein build a comprehensive view of end-to-end real time media session QoE information and map out where performance gaps are causing decreased media quality of the VoIP service. SBCs as well as gateway elements can collect metrics for associated media legs. SBCs can provide these metrics to network control nodes for a respective network. However, in this example, SBCs, gateway elements, and network control nodes can collect metrics for associated media legs and also provide these metrics to associated interface nodes 361-364 in control system 360. Control system 360 is associated with a VoIP platform provided by a VoIP provider, and is not typically operated by the same network operator as transport networks or egress networks in FIG. 3. VoIP control system 360 can be operated by a third-party to any of the other network operators associated with any of the transport networks or egress networks. In some examples, VoIP control system 360 is operated by the same network operator or service provider as originating network 320, however other examples might have originating network 320 associated with a different network provider than VoIP control system 360. Thus, the SBCs included in FIG. 3 can provide the metrics to a third-party that transports communications over the networks associated with the SBCs.

The data collected is used to analyze quality of an ongoing call/session traversing the network elements at various intervals in the session between setup and tear down. Relative quality of the call/session as seen at the network element versus as seen at the far end of the connection can provide an understanding of quality degradation. These examples also include indications of quality metrics, link metrics, and distinction among media paths, media legs, and other information to allow a monitoring system, such as control node 370 to determine media leg degradation and transfer alerts based on this information. Information collected from the network bridging components, such as SBCs, include metrics regarding network conditions, bandwidth limitations, or congestion. Information collected can be used to alter call/application parameters such as codecs, modality used, routes used, and such, to enhance user call experience and minimize media quality degradation.

Each network bridging component (mediation server 322, SBCs 331-332, gateways 341, 351) can monitor and collect quality metrics for associated media legs, such as by using RTCP loops or by receiving quality metrics from associated network elements or network control nodes. These network bridging components provide the quality metrics to an associated I/F nodes 361-364 which then provides the quality metrics to control node 370. Control node 370 can collect these quality metrics in QoE database 371 for processing, later use, and historical comparisons.

In FIG. 3, each network bridging component provides the quality metrics that the associated each network bridging component collects to one of the interface nodes in control system 360 over one or more links. These links can comprise network links, logical links, and can include one or more APIs through which the associated elements can communicate and transfer quality metrics. Furthermore, network control nodes 323, 334, and 353 can also collect quality metrics and transfer to an associated interface node. In some examples, each network bridging component can collect quality metrics from the associated network elements and network control nodes and provide these to the associated interface node.

In the first call example mentioned above, the call to user device 311 is egressed over network 340 which comprises a PSTN network. This PSTN network can include voice gateway 341 and local loop 342 coupled over communication circuit 383. Local loop 342 communicates with user device 311 over PSTN link 387. The quality metrics monitored for PSTN networks can depend on the particular PSTN network operator, and the capabilities of voice gateway 341 with regards to SIP trunking and related communications. In the second call example mentioned above, the call to user device 312 is egressed over network 350, which comprises a wireless or cellular network. This cellular network can include gateway 351 and wireless network 352, which communicates with user device 312 over wireless link 386. The quality metrics monitored for wireless or cellular networks can depend on the particular network operator, and the capabilities of gateway 351 with regards to SIP trunking and related communications.

Advantageously, using the quality metrics collection operations discussed herein, quality differentiation among the transport networks and the PSTN networks or wireless networks can be achieved. Thus, a VoIP call which is initiated over a packet network and transported over one or more SIP trunks handled by SBCs and egressed to a PSTN network can have each media leg monitored for quality degradation. This quality degradation can be isolated and differentiated among each leg and among the IP networks and PSTN networks to determine in which network a quality issue has arisen, and identify one or more legs or network elements that are currently experiencing call quality degradation. The quality metrics collection operations discussed herein have technical effects of reducing processor load of monitoring systems, and increasing degradation alert responsiveness by monitoring VoIP calls that traverse multiple networks which are operated by different network operators. Moreover, the interfaces, such as APIs, discussed herein for SBCs to push or otherwise transfer quality or link metrics to a VoIP monitoring system provide the technical effect of allowing different network elements to communicate even when using different protocols or link types to transfer the link/quality metrics to the quality monitoring systems.

Control node 370 can present one or more user interfaces, such as a quality dashboard, from which operators, users, or other entities can view and monitor call quality metrics for various VoIP calls. Operators of the VoIP service and various entities including users or customers can notice on their dashboards that call quality for calls to a certain service provider for a specific interconnect location are marked as poor quality. The quality metrics collected from the SBCs along with routing details help reduce the time to isolate where a root cause is for quality degradation of a VoIP call.

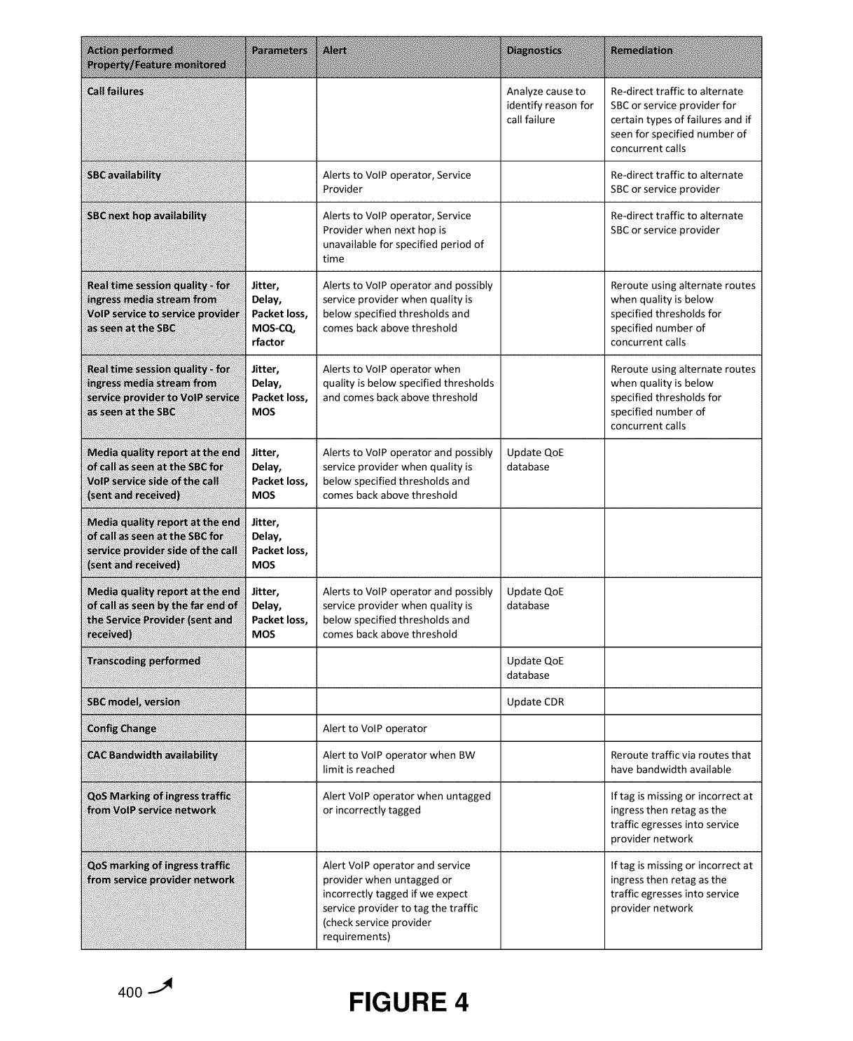

FIG. 4 is a table illustrating example quality metrics that can be monitored by SBCs or other elements of FIG. 3 and provided to interface nodes 361-364 for monitoring and processing by control node 370. Table 400 in FIG. 4 lists various aspects of media quality that can be monitored by a specific device in the media path and used to generate alerts when specific conditions arise and to further diagnose and remediate issues seen in the media path. Table 400 specifies SBCs, both on-premises and online (provider edge SBCs), but table 400 can also apply to gateways (such as gateways 341, 351), private branch exchanges (PBXs), and in hybrid deployments.

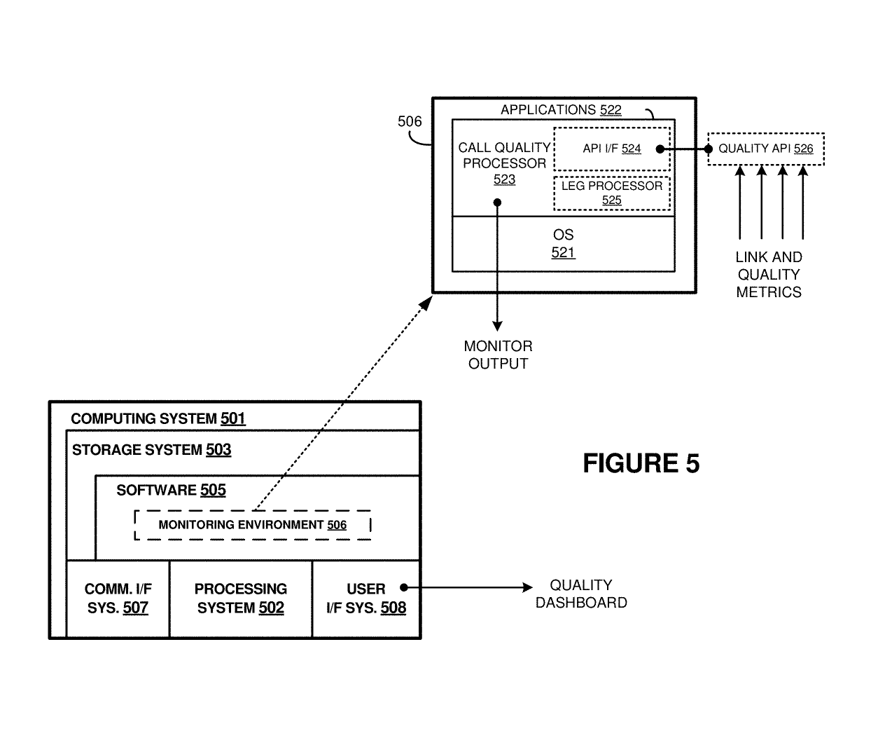

FIG. 5 illustrates computing system 501 that is representative of any system or collection of systems in which the various operational architectures, scenarios, and processes disclosed herein may be implemented. For example, computing system 501 can be used to implement any of monitor node 120 of FIG. 1 or control system 360 of FIG. 3. Examples of computing system 501 include, but are not limited to, server computers, cloud computing systems, distributed computing systems, software-defined networking systems, computers, desktop computers, hybrid computers, rack servers, web servers, cloud computing platforms, and data center equipment, as well as any other type of physical or virtual server machine, and other computing systems and devices, as well as any variation or combination thereof.

Computing system 501 may be implemented as a single apparatus, system, or device or may be implemented in a distributed manner as multiple apparatuses, systems, or devices. Computing system 501 includes, but is not limited to, processing system 502, storage system 503, software 505, communication interface system 507, and user interface system 508. Processing system 502 is operatively coupled with storage system 503, communication interface system 507, and user interface system 508.

Processing system 502 loads and executes software 505 from storage system 503. Software 505 includes monitoring environment 506, which is representative of the processes discussed with respect to the preceding Figures.

When executed by processing system 502 to enhance VoIP monitoring and quality differentiation/isolation for VoIP systems, software 505 directs processing system 502 to operate as described herein for at least the various processes, operational scenarios, and sequences discussed in the foregoing implementations. Computing system 501 may optionally include additional devices, features, or functionality not discussed for purposes of brevity.

Referring still to FIG. 5, processing system 502 may comprise a micro-processor and processing circuitry that retrieves and executes software 505 from storage system 503. Processing system 502 may be implemented within a single processing device, but may also be distributed across multiple processing devices or sub-systems that cooperate in executing program instructions. Examples of processing system 502 include general purpose central processing units, application specific processors, and logic devices, as well as any other type of processing device, combinations, or variations thereof.

Storage system 503 may comprise any computer readable storage media readable by processing system 502 and capable of storing software 505. Storage system 503 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 503 may also include computer readable communication media over which at least some of software 505 may be communicated internally or externally. Storage system 503 may be implemented as a single storage device, but may also be implemented across multiple storage devices or sub-systems co-located or distributed relative to each other. Storage system 503 may comprise additional elements, such as a controller, capable of communicating with processing system 502 or possibly other systems.

Software 505 may be implemented in program instructions and among other functions may, when executed by processing system 502, direct processing system 502 to operate as described with respect to the various operational scenarios, sequences, and processes illustrated herein. For example, software 505 may include program instructions for implementing VoIP monitoring and quality differentiation/isolation for VoIP platforms.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 505 may include additional processes, programs, or components, such as operating system software or other application software, in addition to or that include monitoring environment 506. Software 505 may also comprise firmware or some other form of machine-readable processing instructions executable by processing system 502.

In general, software 505 may, when loaded into processing system 502 and executed, transform a suitable apparatus, system, or device (of which computing system 501 is representative) overall from a general-purpose computing system into a special-purpose computing system customized to facilitate enhanced VoIP monitoring and quality differentiation/isolation for VoIP systems. Indeed, encoding software 505 on storage system 503 may transform the physical structure of storage system 503. The specific transformation of the physical structure may depend on various factors in different implementations of this description. Examples of such factors may include, but are not limited to, the technology used to implement the storage media of storage system 503 and whether the computer-storage media are characterized as primary or secondary storage, as well as other factors.

For example, if the computer readable storage media are implemented as semiconductor-based memory, software 505 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Monitoring environment 506 includes one or more software elements, such as OS 521 and applications 522. These elements can describe various portions of computing system 501 with which network nodes, such as SBCs, interact. For example, OS 521 can provide a software platform on which application 522 is executed and allows for receipt of quality/link metrics and monitoring quality/link metrics that are received from SBCs over quality API 526 and API interface (I/F) 524.

In one example, call quality processor 523 includes API I/F 524 and leg processor 525. API I/F 524 provide quality APIs 526 which each interact with an associated SBC or other network element that handles VoIP calls and monitors VoIP call quality. Quality APIs 526 receive quality/link metrics from an associated SBC and stores these quality/link metrics in storage system 503 for processing by leg processor 525. Leg processor 525 processes the quality/link metrics to identify VoIP call quality degradation and to differentiate and localize where the VoIP call quality degradation occurs among the various network elements (such as SBCs). For example, leg processor can identify an SBC or an associated SIP trunk which is experiencing link or quality degradation by at least processing the link/quality metrics received over quality APIs 526 that are provided by API I/F 524. In some examples, API I/F 524 are not included and quality APIs 526 are provided by other elements of call quality processor 523 or by call quality processor 523 directly.

In another example, monitoring environment 506 provides one or more outputs, which can be used to generate alerts, notify end users or network providers of the link/quality degradation, or other information. For example, a quality dashboard can be provided by user interface system 508, which provides statistics, information, status, or other quality data related to current VoIP call quality as monitored by call quality processor 523.

Communication interface system 507 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. Physical or logical elements of communication interface system 507 can receive link/quality metrics, and provide link/quality alerts or dashboard outputs to users or other operators.

User interface system 508 is optional and may include a keyboard, a mouse, a voice input device, a touch input device for receiving input from a user. Output devices such as a display, speakers, web interfaces, terminal interfaces, and other types of output devices may also be included in user interface system 508. User interface system 508 can provide output and receive input over a network interface, such as communication interface system 507. In network examples, user interface system 508 might packetize display or graphics data for remote display by a display system or computing system coupled over one or more network interfaces. Physical or logical elements of user interface system 508 can provide link/quality alerts or dashboard outputs to users or other operators. User interface system 508 may also include associated user interface software executable by processing system 502 in support of the various user input and output devices discussed above. Separately or in conjunction with each other and other hardware and software elements, the user interface software and user interface devices may support a graphical user interface, a natural user interface, or any other type of user interface.

Communication between computing system 501 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transmission control protocol (TCP), and the user datagram protocol (UDP), as well as any other suitable communication protocol, variation, or combination thereof.

Certain inventive aspects may be appreciated from the foregoing disclosure, of which the following are various examples.

### EXAMPLE 1

A network telephony monitoring system, comprising a monitoring service configured to present an interface for the network telephony monitoring system to receive link metrics for media legs of a packet voice call that extends from an originating network over a plurality of transport networks, with each of the media legs spanning between border control nodes of the plurality of transport networks. The network telephony monitoring system comprising a leg quality processor configured to process the link metrics to differentiate quality degradation of the packet voice call between one or more of the media legs.

### EXAMPLE 2

The monitoring system of Example 1, wherein the border control nodes comprise session border controllers (SBCs), and wherein the media legs each comprise a Session Initiation Protocol (SIP) trunk.

### EXAMPLE 3

The monitoring system of Examples 1-2, wherein the interface presented by the monitoring service comprises one or more software defined network (SDN) interface elements configured to interface with at least the border control nodes to receive the link metrics and provide the link metrics to the leg quality processor.

### EXAMPLE 4

The monitoring system of Examples 1-3, wherein the SDN interface elements each comprise an application programming interface (API) configured to receive the link metrics as pushed to associated APIs by the border control nodes.

### EXAMPLE 5

The monitoring system of Examples 1-4, wherein the link metrics are established by at least the border control nodes using Real-time Transport Protocol (RTP) Control Protocol (RTCP) loops established for associated ones of the media legs.

### EXAMPLE 6

The monitoring system of Examples 1-5, wherein the link metrics comprise network condition metrics, bandwidth limitation metrics, congestion metrics, jitter metrics, packet loss metrics, Mean Opinion Score (MOS) metrics, transmitted octet counts, packet counts, packet delay variation metrics, and round-trip delay times.

### EXAMPLE 7

The monitoring system of Examples 1-6, wherein ones of the media legs comprise Session Initiation Protocol (SIP) trunks that carry the packet voice call and couple session border controllers (SBCs) of associated transport networks operated by different network operators than the originating network.

### EXAMPLE 8

The monitoring system of Examples 1-7, responsive to differentiating the quality degradation of the packet voice call among one or more of the media legs, the leg quality processor configured to transfer one or more alerts indicating at least one of the media legs associated with the quality degradation.

### EXAMPLE 9

The monitoring system of Examples 1-8, responsive to differentiating the quality degradation of the packet voice call among one or more of the media legs, the leg quality processor configured to alter service parameters employed for the packet voice call, the service parameters comprising at least one of a codec and a route.

### EXAMPLE 10

A method of operating a network telephony monitoring system, comprising presenting an interface for the network telephony monitoring system to receive link metrics for media legs of a packet voice call that extends from an originating network over a plurality of transport networks, with each of the media legs spanning between border control nodes of the plurality of transport networks, and processing the link metrics to differentiate quality degradation of the packet voice call among one or more of the media legs.

### EXAMPLE 11

The method of Example 10, wherein the border control nodes comprise session border controllers (SBCs), and wherein the media legs each comprise a Session Initiation Protocol (SIP) trunk.

### EXAMPLE 12

The method of Examples 10-11, wherein the interface comprises one or more software defined network (SDN) interface elements configured to interface with at least the border control nodes to receive the link metrics and provide the link metrics to the leg quality processor.

EXAMPLE 13

The method of Examples 10-12, wherein the SDN interface elements each comprise an application programming interface (API) configured to receive the link metrics as pushed to associated APIs by the border control nodes.

### EXAMPLE 14

The method of Examples 10-13, wherein the link metrics are established by at least the border control nodes using Real-time Transport Protocol (RTP) Control Protocol (RTCP) loops established for associated ones of the media legs.

### EXAMPLE 15

The method of Examples 10-14, wherein the link metrics comprise network condition metrics, bandwidth limitation metrics, congestion metrics, jitter metrics, packet loss metrics, Mean Opinion Score (MOS) metrics, transmitted octet counts, packet counts, packet delay variation metrics, and round-trip delay times.

### EXAMPLE 16

The method of Examples 10-15, wherein ones of the media legs comprise Session Initiation Protocol (SIP) trunks that carry the packet voice call and couple session border controllers (SBCs) of associated transport networks operated by different network operators than the originating network.

### EXAMPLE 17

The method of Examples 10-16, responsive to differentiating the quality degradation of the packet voice call among one or more of the media legs, transferring one or more alerts indicating at least one of the media legs associated with the quality degradation.

### EXAMPLE 18

The method of Examples 10-17, responsive to differentiating the quality degradation of the packet voice call among one or more of the media legs, altering service parameters employed for the packet voice call, the service parameters comprising at least one of a codec and a route.

### EXAMPLE 19

A Voice over Internet Protocol (VoIP) call monitoring system, comprising one or more software defined network (SDN) interface elements configured to receive quality metrics transferred by session border controllers (SBCs) for associated Session Initiation Protocol (SIP) trunks of a VoIP call that extends from an originating network over a plurality of transport packet networks operated by different network operators than the originating network, with each of the SIP trunks spanning between ones of the SBCs of the plurality of transport packet networks. The Voice over Internet Protocol (VoIP) call monitoring system comprising a call quality processor configured to process the quality metrics to identify ones of the SIP trunks experiencing quality degradation for the VoIP call.

### EXAMPLE 20

The VoIP call monitoring system of Example 19, responsive to identifying the ones of the SIP trunks experiencing the quality degradation for the VoIP call, the call quality processor configured to alter service parameters employed for the VoIP call, the service parameters comprising at least one of a codec and a route.

### EXAMPLE 21

A session border controller (SBC) comprising:

one or more computer readable storage media; a processing system operatively coupled with the one or more computer readable storage media; and program instructions stored on the one or more computer readable storage media that, when executed by the processing system, direct the processing system to at least: report quality information for a media stream to a monitoring node associated with an incoming call leg and external to a transport network associated with the SBC; and report quality information for a another media stream to a another monitoring node associated with another incoming call leg and external to the transport network associated with the SBC.

In an additional example, various service hubs may be co-located with an SBC. Each service hub may be associated with a different Internet telephony service provider (e.g. Skype®) such that the telephony provider may route its off-net calls to the transit provider associated with the SBC. Thus, calls originating with the service provider that are destined for an off-net termination point may be routed to the SBC for transport to an egress network.

As the SBC may host multiple hubs for the multiple service providers, the SBC may include a framework for discriminating between the various incoming calls in order to provide call quality functionality to all of the providers. For example, a call incoming into the SBC for one provider may trigger the SBC to establish a corresponding stream between it and another downstream SBC to carry the traffic for call. Per the disclosure above, the SBC may report call quality metrics via an API between it and a monitoring node in the service provider's network—even though the SBC is external to the network.

At or near the same time as the first call, the SBC may receive another call, but from a different service provider. For example, the first call may originate from Skype®, whereas the second call may originate from Google®. The SBC may setup another stream between itself and a downstream SBC in order to transport the call. In addition, per the disclosure above, the SBC may communicate call quality metrics on the intermediate leg of the call to a monitoring node in Google's network.

Thus, the SBC is capable of calling into two different monitoring nodes—one associated with one service provider and another associated with another service provider. The SBC may also include functionality allowing it to communicate quality metrics to its own monitoring node. For instance, the transport provider may operate a monitoring facility into which the SBC reports quality metrics on a per-stream basis, a per-trunk basis, or at any other level of granularity. In other words, the enhanced SBC represents a technical effect in its ability to report quality metrics to both its own internal monitoring layer and externally to monitoring systems associated external network operators.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A network telephony monitoring system, comprising:
a monitoring service configured to present an interface for the network telephony monitoring system to receive link metrics for media legs of a packet voice call that extends from an originating network over a plurality of transport networks, with each of the media legs spanning between border control nodes of the plurality of transport networks;
a leg quality processor configured to process the link metrics to differentiate quality degradation of the packet voice call among one or more of the media legs.

2. The monitoring system of claim 1, wherein the border control nodes comprise session border controllers (SBCs), and wherein the media legs each comprise a Session Initiation Protocol (SIP) trunk.

3. The monitoring system of claim 1, wherein the interface presented by the monitoring service comprises one or more software defined network (SDN) interface elements configured to interface with at least the border control nodes to receive the link metrics and provide the link metrics to the leg quality processor.

4. The monitoring system of claim 3, wherein the SDN interface elements each comprise an application programming interface (API) configured to receive the link metrics as pushed to associated APIs by the border control nodes.

5. The monitoring system of claim 1, wherein the link metrics are established by at least the border control nodes using Real-time Transport Protocol (RTP) Control Protocol (RTCP) loops established for associated ones of the media legs.

6. The monitoring system of claim 1, wherein the link metrics comprise network condition metrics, bandwidth limitation metrics, congestion metrics, jitter metrics, packet loss metrics, Mean Opinion Score (MOS) metrics, transmitted octet counts, packet counts, packet delay variation metrics, and round-trip delay times.

7. The monitoring system of claim 1, wherein ones of the media legs comprise Session Initiation Protocol (SIP) trunks that carry the packet voice call and couple session border controllers (SBCs) of associated transport networks operated by different network operators than the originating network.

8. The monitoring system of claim 1, comprising:
responsive to differentiating the quality degradation of the packet voice call among one or more of the media legs, the leg quality processor configured to transfer one or more alerts indicating at least one of the media legs associated with the quality degradation.

9. The monitoring system of claim 1, comprising:
responsive to differentiating the quality degradation of the packet voice call among one or more of the media legs, the leg quality processor configured to alter service parameters employed for the packet voice call, the service parameters comprising at least one of a codec and a route.

10. A method of operating a network telephony monitoring system, comprising:
presenting an interface for the network telephony monitoring system to receive link metrics for media legs of a packet voice call that extends from an originating network over a plurality of transport networks, with each of the media legs spanning between border control nodes of the plurality of transport networks;
processing the link metrics to differentiate quality degradation of the packet voice call among one or more of the media legs.

11. The method of claim 10, wherein the border control nodes comprise session border controllers (SBCs), and wherein the media legs each comprise a Session Initiation Protocol (SIP) trunk.

12. The method of claim 10, wherein the interface comprises one or more software defined network (SDN) interface elements configured to interface with at least the border control nodes to receive the link metrics and provide the link metrics to the leg quality processor.

13. The method of claim 12, wherein the SDN hubs interface elements comprise an application programming interface (API) configured to receive the link metrics as pushed to associated APIs by the border control nodes.

14. The method of claim 10, wherein the link metrics are established by at least the border control nodes using Real-time Transport Protocol (RTP) Control Protocol (RTCP) loops established for associated ones of the media legs.

15. The method of claim 10, wherein the link metrics comprise network condition metrics, bandwidth limitation metrics, congestion metrics, jitter metrics, packet loss metrics, Mean Opinion Score (MOS) metrics, transmitted octet counts, packet counts, packet delay variation metrics, and round-trip delay times.

16. The method of claim 10, wherein ones of the media legs comprise Session Initiation Protocol (SIP) trunks that carry the packet voice call and couple session border controllers (SBCs) of associated transport networks operated by different network operators than the originating network.

17. The method of claim 10, further comprising:
responsive to differentiating the quality degradation of the packet voice call among one or more of the media legs, transferring one or more alerts indicating at least one of the media legs associated with the quality degradation.

18. The method of claim 10, further comprising:
responsive to differentiating the quality degradation of the packet voice call among one or more of the media legs, altering service parameters employed for the packet voice call, the service parameters comprising at least one of a codec and a route.

19. A Voice over Internet Protocol (VoIP) call monitoring system, comprising:
one or more software defined network (SDN) interface elements configured to receive quality metrics transferred by session border controllers (SBCs) for associated Session Initiation Protocol (SIP) trunks of a VoIP call that extends from an originating network over a plurality of transport packet networks operated by different network operators than the originating network, with each of the SIP trunks spanning between ones of the SBCs of the plurality of transport packet networks;
a call quality processor configured to process the quality metrics to identify ones of the SIP trunks experiencing quality degradation for the VoIP call.

20. The VoIP call monitoring system of claim 19, comprising:
responsive to identifying the ones of the SIP trunks experiencing the quality degradation for the VoIP call, the call quality processor configured to alter service parameters employed for the VoIP call, the service parameters comprising at least one of a codec and a route.
